(19) United States
(12) Patent Application Publication
(10) Pub. No.: US 2002/0111986 A1
(43) Pub. Date: Aug. 15, 2002

(54) Integration of messaging functions and database operations

(76) Inventor: Charles D. Wolfson, Austin, TX (US)

Correspondence Address: Joseph A. Sawyer, Jr., Sawyer Law Group LLP, P.O. Box 51418, Palo Alto, CA, 94303, US

(21) Appl. No.: 09/731,088

(22) Filed: Dec. 5, 2000

(51) Int. Cl. G06F 7/00

(52) U.S. Cl. 709/200

(57) ABSTRACT

Aspects for integrating messaging functionality into database operations are described. The aspects include providing one or more chosen functions from a messaging system in a database system. The one or more chosen functions from the database system are then utilized within structured query language statements to access the messaging system from the database system.

### FIELD OF THE INVENTION

The present invention relates to messaging functions, and more particularly to integrating messaging functions in database operations.

### BACKGROUND OF THE INVENTION

Just as computers have become more and more prevalent in everyday life, networks of linked computers have become important in distributing information amongst computer users. Many computer systems are organized according to a client/server metaphor. In client/server computing, in general, end users are each provided with a desktop computer or terminal known as a “client.” The clients are connected using a network to another computer known as a “server”, because its general function is to serve or fulfill requests submitted by clients. Application programs running on the clients prepare requests and transmit them to the server over the network. A ‘network’ of computers can be any number of computers that are able to exchange information with one another. The computers may be arranged in any configuration and may be located in the same room or in different countries, so long as there is some way to connect them together (for example, by telephone lines or other communication systems) so they can exchange information. Just as computers may be connected together to make up a network, networks may also be connected together through tools known as bridges and gateways. These tools allow a computer in one network to exchange information with a computer in another network.

In order to account for the fact that different computers connected to such a network may operate using different protocols and/or data formats, and also that different computers may be located in different time zones, asynchronous messaging and queuing software products have been developed. Queuing can be used to implement deferred execution of work. In a system with queuing, a request for work is entered into a queue of requests, and the system defers processing of the request until later, such as when the requesting process has completed the task, process, or transaction that created the request. Queuing has been recognized as an important component of systems that mimic human business processes or work flow.

The following provides some basic concepts of messaging and queuing. Messaging and queuing provide a method of inter-program communication which allows programs to send and receive application-specific data without having a direct connection established between them. A message consists of two parts—application data and a message descriptor containing control information. The application data in a message is defined and supplied by the application program which sends the message. There are no constraints on the nature of the data in a message (for example, it could consist of one or more bit strings, character strings, binary integers, etc). Applications view the string of bits and bytes that make up a message as consisting of a sequence of items which each have a particular meaning and data type. In addition to the application data, a message has associated with it some ancillary data. This is information that specifies the properties of the message, and is used by the message queuing service to decide how the message should be processed. Some of this information must be specified by the sending application.

A message queue is a named object in which messages accumulate and from which they are later removed. Each queue belongs to one particular queue manager (which is the system service that provides the message-queuing facilities used by applications), and the queue manager is responsible for the maintenance of that queue. A message queue is not merely a stack: when messages are added to a queue, they are added at the end, and when messages are taken from a queue they are normally removed from the front (although facilities do exist for reading messages in other than FIFO (first-in first-out) order). The physical representation of a message queue depends on the environment but can be a buffer or buffers in main storage, a file or files on disk or other permanent storage device, or both of these. The physical management of message queues is entirely the responsibility of a queue manager, and such details are not made apparent to application programs. Applications can view a message queue simply as a “black box” in which messages accumulate. Applications have access to message queues by using message queuing API (application program interface) calls—obtaining message queuing services by using the message queuing calls to communicate with the queue manager that is installed on the same system as the application (i.e. the local queue manager).

Applications communicate by agreeing to use particular named message queues, sending messages to the specific target queues that the application programs have agreed to read from. The locations of these queues need not be apparent to the applications which send the messages; each application interacts only with its local queue manager, and it is the network of interconnected queue managers that is responsible for moving the messages to the intended queues. In this way, the message queuing software greatly simplifies the level of complexity that is required of the application programs, removing the need for them to implement their own complex communications controls. By way of example, message queuing communication between programs, using batch transfer of messages between adjacent network nodes is provided by the MQSeries family of software products from IBM Corporation, Armonk, N.Y.

While a variety of applications are able to communicate via message queues, of particular interest in today's computing environment are relational database applications. Relational DataBase Management System (RDBMS) software using a Structured Query Language (SQL) interface is well known in the art. The SQL interface has evolved into a standard language for RDBMS software and has been adopted as such by both the American Nationals Standard Organization (ANSI) and the International Standards Organization (ISO).

In RDBMS software, all data is externally structured into tables. The SQL interface allows users to formulate relational operations on the tables either interactively, in batch files, or embedded in host languages such as C, COBOL, etc. Operators are provided in SQL that allow the user to manipulate the data, wherein each operator operates on either one or two tables and produces a new table as a result. The power of SQL lies on its ability to link information from multiple tables or views together to perform complex sets of procedures with a single statement.

A need exists for an integration of the power of SQL with the message queuing communication to produce applications that seamlessly combine messaging and database access. The present invention addresses such a need.

### SUMMARY OF THE INVENTION

The present invention provides aspects for integrating messaging functionality into database operations. The aspects include providing one or more chosen functions from a messaging system in a database system. The one or more chosen functions from the database system are then utilized within structured query language statements to access the messaging system from the database system.

The present invention utilizes the mechanisms provided by SQL to allow a database query to be formed that incorporates messaging function operations within an SQL statement. Following the SQL standard, these messaging functions may be used wherever a function is allowed in SQL. These and other advantages of the aspects of the present invention will be more fully understood in conjunction with the following detailed description and accompanying drawings.

### BRIEF DESCRIPTION OF THE DRAWINGS

FIG. 1 illustrates an overall block diagram of a computer system network in accordance with the present invention.

FIG. 2 illustrates a block flow diagram for integration of messaging functions and database operations in accordance with the present invention.

### DETAILED DESCRIPTION OF THE INVENTION

The present invention relates to integration of messaging functions and database operations. The following description is presented to enable one of ordinary skill in the art to make and use the invention and is provided in the context of a patent application and its requirements. Thus, the present invention is not intended to be limited to the embodiment shown, but is to be accorded the widest scope consistent with the principles and features described herein.

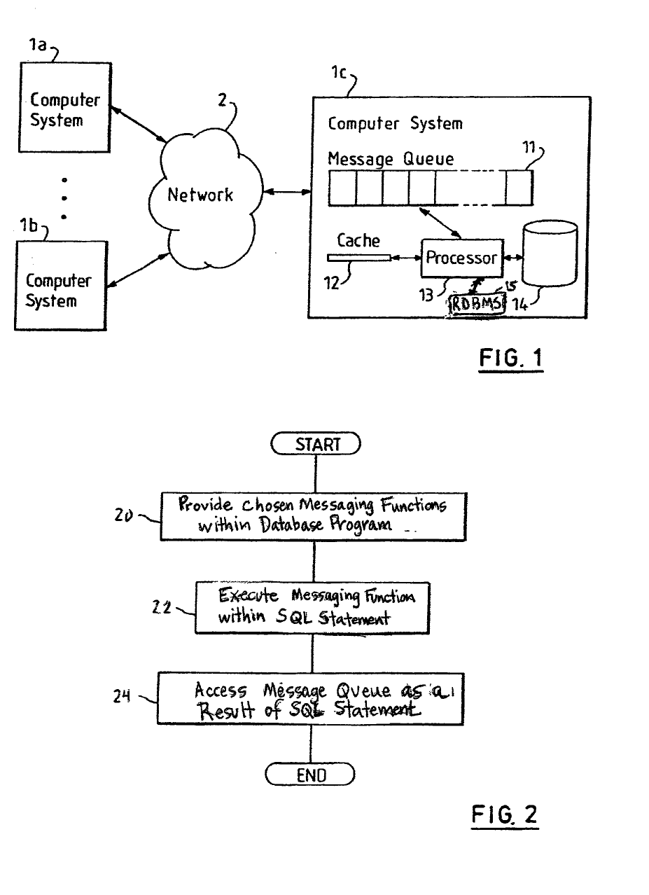

As shown in FIG. 1, a plurality of computer systems 1a, 1b, 1c are interconnected via a network 2 (which could be the public Internet or a private intra-corporate Intranet or wide area network). It should be appreciated that although FIG. 1 illustrates a network of computer systems, this is meant as exemplary and not restrictive of the type of environment suitable for the aspects of the present invention. Thus, the aspects may also be provided within a single computing system environment. Accordingly, one (1c) of the computer systems is shown expanded for further illustration.

Computer system 1c has a processor 13 for controlling the overall operation of the computer system 1c, a high speed cache memory 12, a long-term storage device 14 (e.g., hard disk drive), a message queue 11 managed by messaging software/a message queue manager (e.g., MQSeries) running on the computer system 1c, and a database program mechanism 15, e.g., an RDBMS system, such as DB2. In general, there exists a hierarchy of data processing system resources that includes a message oriented middleware on top of the operating system (using the operating system resources) and underlying the application programs. The messaging software provides support for a number of application programs, which are the business applications run by a system user (e.g. an airline passenger booking facility run by a travel agency). It should be noted that the message queue (when persistence is desired) and database would usually exist in the long-term storage device 14 (or other suitable computer readable medium), but these items have been shown separately in FIG. 1 for functional clarity.

During messaging operations, whenever a new message destined for computer system 1c is received over network 2 from one of the other computer systems (e.g., 1a or 1b) the message is stored in the message queue 11. The data associated with the message is stored in long term storage 14 when persistence is desired. When the processor 13 requests that a particular message be dequeued, that message's associated data is retrieved from storage 14 and provided to processor 13.

In accordance with the present invention, messages provided to or received from message queue 11 include those resulting directly from SQL statements executed in the RDBMS system 15. The integration of messaging software functionality into database operations with the present invention is achieved through a straightforward approach that utilizes the mechanisms provided by SQL to allow a database query to be formed that incorporates messaging operations within a SQL statement. In this manner, the SQL statement appears in itself as an application to the messaging software.

FIG. 2 illustrates an overall block flow diagram of messaging and database integration. The integration includes providing a chosen set of messaging functions within a database application (step 20). Preferably, the chosen set of functions is provided by defining the functions as user-defined functions within the database application through the use of standard function definition techniques, as are well understood to those skilled in the art. User-defined functions (UDFs) form the most interesting primitives within the system. Because they form part of a SQL statement, UDFs allow the seamless blending of queuing and database operations together. Alternatively, the set of functions may be defined through standard techniques as built-in functions within the database applications.

In accordance with a preferred embodiment, messaging functions are provided that support messaging operations within a query and can be used to publish data selected through SQL, to join the contents of message queue with relational databases, and to publish data changes through triggers. With the messaging functions, procedures are also possible to support decoupled, transactional messaging within a database application to send and receive messages within the same unit of work as SQL operations. These messaging functions preferably include functions to place a message on a queue, retrieve a message from a queue, retrieve all messages from a queue, and non-destructively retrieve all messages from a queue. Of course, the set of functions may also be defined to allow users to explicitly set the name of the service endpoint, and optionally specify the destination policy/quality of service, e.g. high priority, low priority. Further, the functions included herein are meant as an exemplary group of functions but may include other functions, if desired. In this disclosure, a service refers to a logical name indicating the destination to which a message should be sent to or received from. It may represent a single physical queue or it may represent a distribution list containing multiple target queue names for MQ series, physical queues are described as a particular combination of queue manager and queue name. A given machine may be configured to run one or more queue managers each of which may control one or more queues.

Once the messaging functions are defined as a part of the database applications, the defined functions are then utilized by execution within a SQL statement (step 22). The execution of the SQL statement occurs as would normally be done by the database application with the added benefit that the result of the SQL statement execution would access the message queue directly (step 24). By way of example, the following provides pseudo-SQL statements that demonstrate the integration of messaging functionality and database operations, such as for the following employee table definition.

| | | | |
|---|---|---|---|
| Employee Name | Dept. | Level | Job |
| (empName) | | | |

put a message containing the string “old” to a queue

VALUES putm(‘old’);

put one message containing the string “another row” to the queue for each row in the

employee table

SELECT putm(‘another row’) FROM employee;

put one message containing the empName column to a queue for each row in the

employee table

SELECT putm(empName) FROM employee;

put one message containing the concatenated empName and dept to the queue for

each row where the employee level is greater than 8

SELECT putm(empName ∥‘ ’∥ dept) FROM employee WHERE level >8;

retrieve the message at the head of the queue

VALUES getm( );

read the message at the head of the queue

VALUES readm( );

return a table containing one row for each entry in the queue—the queue is emptied by

this operation

SELECT T.* FROM TABLE (getq( )) t

return a table containing one row for each entry in the queue—the queue is not emptied

by this operation

SELECT T. * FROM TABLE(readq( )) t

insert an employee name into the employee table for each message

INSERT INTO employee (empName) SELECT * FROM TABLE (getq( ))t

define a database trigger to put a message to the queue each time a new employee is inserted into the employee table

CREATE TRIGGER new_employee AFTER INSERT ON employee

REFERENCING NEW AS n

FOR EACH ROW MODE DB2SQL

VALUES putm(empName ∥‘ ’∥ dept)

define a SQL stored procedure to put a message to a queue

CREATE PROCEDURE putmsg (IN VARCHAR(50) message, OUT result)

LANGUAGE SQL

SET result=VALUES putm(message);

Publish a message on the topic new_employee containing all the employees in the employee table. This would then allow any number of subscribers to the new_employee topic to receive these messages.

SELECT publishm(‘new_employees’, lastname II‘ ’II firstnme) from employee

As demonstrated by these example SQL statements, a wide range of uses are available from a set of chosen messaging functions added to the database system. Further, the queuing and database operations are seamlessly blended together through the execution of these messaging functions within the SQL statements. In this manner, access is conveniently and efficiently provided to messaging software from SQL to allow current database programs to leverage the advantages of messaging into their operations. The straightforward approach of the present invention is also more intuitive to database developers and administrators, since it provides the messaging capabilities within the traditional database programming context, i.e., adding the messaging functions as UDFs.

Although the present invention has been described in accordance with the embodiments shown, one of ordinary skill in the art will readily recognize that there could be variations to the embodiments and those variations would be within the spirit and scope of the present invention. For example, although the present invention has been described with reference to a queue-based messaging system, the principles can also be applied with a publish/subscribe-based system, as is well appreciated by those skilled in the art. Accordingly, many modifications may be made by one of ordinary skill in the art without departing from the spirit and scope of the appended claims.

What is claimed is:

1. A method for integrating messaging functionality into database operations, the method comprising:
(a) providing one or more chosen functions from a messaging system in a database system; and
(b) utilizing the one or more chosen functions from the database system within structured query language statements to access the messaging system from the database system.

2. The method of claim 1 wherein step (a) further comprising (a1) adding the one or more chosen functions as user-defined functions in the database system.

3. The method of claim 2 wherein the user defined functions further comprise functions to place a message on a queue of the messaging system, retrieve at least one message from the queue, non-destructively retrieve all messages from the queue, and read at least one message from the queue.

4. The method of claim 3 wherein the user-defined functions further specify a service endpoint.

5. The method of claim 4 wherein the user-defined functions further specify a destination and delivery policy.

6. The method of claim 1 further comprising providing one or more chosen functions from a publish/subscribe-based messaging system.

7. A system for integrating messaging functionality into database operations, the system comprising:
at least one computer processing device;
a messaging program means installed on the at least one computer processing device for performing messaging functionality; and
a database program means installed on the at least one computer processing device, the database program means utilizing one or more chosen functions of the messaging program means via structured query language statements to integrate the messaging functionality within database functionality of the database program means.

8. The system of claim 7 wherein the one or more chosen functions further comprise user-defined functions in the database program means.

9. The system of claim 8 wherein the user-defined functions further comprise a functions to place a message on a queue of the messaging system, retrieve at least one message from the queue, non-destructively retrieve all messages from the queue, and read at least one message from the queue.

10. The system of claim 9 wherein the user-defined functions further specify a service endpoint.

11. The system of claim 10 wherein the user-defined functions further specify a delivery policy.

12. The system of claim 7 wherein the messaging program means further comprises a publish/subscribe-based messaging program means.

13. A computer readable medium containing program instructions for integrating messaging functionality into database operations, the program instructions comprising:
(a) providing one or more chosen functions from a messaging system in a database system; and
(b) utilizing the one or more chosen functions from the database system within structured query language statements to access the messaging system from the database system.

14. The program instructions of claim 13 wherein step (a) further comprising (a1) adding the one or more chosen functions as user-defined functions in the database program.

15. The program instructions of claim 14 wherein the user-defined functions further comprise a functions to place a message on a queue of the messaging system, retrieve at least one message from the queue, non-destructively retrieve all messages from the queue, and read at least one message from the queue.

16. The program instructions of claim 15 wherein the user-defined functions further specify a service endpoint.

17. The program instructions of claim 16 wherein the user-defined functions further specify a destination and delivery policy.

18. The program instructions of claim 13 further comprising providing one or more chosen functions from a publish/subscribe-based messaging system.
